(19) United States
(12) Patent Application Publication
(10) Pub. No.: US 2024/0152512 A1
(43) Pub. Date: May 9, 2024

(54) MACHINE LEARNING FOR DYNAMIC INFORMATION RETRIEVAL IN A COLD START SETTING

(71) Applicant: Zulily, LLC, Seattle, WA (US)

(72) Inventors: Tim Decker, Seattle, WA (US); Eowyn Baughman, Seattle, WA (US); Sean McCain, Seattle, WA (US); Sasha Bartashnik, Seattle, WA (US); Tyan Hynes, Seattle, WA (US)

(21) Appl. No.: 17/980,487

(22) Filed: Nov. 3, 2022

(51) Int. Cl. G06F 16/2453; G06Q 30/02

(52) U.S. Cl. CPC G06F 16/2453; G06Q 30/0201

(57) ABSTRACT

Methods and systems described herein may improve search results for items newly added to a database by using machine learning to map historical items in the database to the newly added items. For example, non-conventional methods and systems described herein may use machine learning generated embeddings (e.g., vector representations of items) to determine the extent to which two items are similar to each other. The computing system may assign engagement data associated with a first item to a second item that lacks engagement data. By doing so, the computing system may enable improved search results because the position of items that lack engagement data (e.g., newly added items) may be adjusted based on engagement data associated with similar items.

### BACKGROUND

Search engines provide users with relevant search results in response to user search queries. For example, a web search engine generates a list of relevant websites and a computational search engine generates a list of relevant answers to science or engineering questions, etc. Search engines allow users to quickly and easily find information that is of genuine interest or value, without the need to wade through irrelevant data, and thus it is important for search results to contain items that are relevant to what a user has searched for.

To obtain relevant results, search engines may create an index based on text or other data associated with items in a database (e.g., websites, data structures, items, etc.). The search engine may also rank the order in which items are provided in search results, based on a variety of factors, including historical data associated with items (e.g., the history of users engaging with items returned in previous search results).

Items newly added to the database (e.g., a newly created website) may lack historical data, and therefore it can be challenging to determine how the new items should be ranked in a search result. This challenge, where an item is added to a search system without historical data, is known as a type of cold start problem in information retrieval. It would therefore be desirable to improve the manner in which relevant items are identified in a cold start setting.

### BRIEF DESCRIPTION OF THE DRAWINGS

FIG. 1 is an illustrative diagram of a system for using machine learning with information retrieval, in accordance with one or more embodiments of a cold start search system.

FIG. 2 illustrates example item embeddings, in accordance with one or more embodiments of a cold start search system.

FIG. 3 is a network diagram illustrating an exemplary computing environment in which a cold start search system operates.

FIG. 4 is a flow diagram illustrating an exemplary process for identifying items relevant to a search query, in accordance with one or more embodiments of a cold start search system.

The techniques introduced in this disclosure can be better understood by referring to the following Detailed Description in conjunction with the accompanying drawings.

### DETAILED DESCRIPTION

A system to provide relevant search results in a cold start setting, in which items may lack historical data (the “cold start search system”), and associated methods, is disclosed herein.

The cold start search system maintains a database of items, which represents the set of possible items that may be provided in response to search queries (e.g., websites that can be returned by the system in response to a web search, items available on a website that can be returned by the system in response to a search, etc.). Further, the system can generate an index, based on text or other data associated with items in a database, by processing and analyzing content associated with each item in the database (e.g., keywords found on a website or characterizing an item).

As described herein, the cold start search system utilizes the index, as well as other maintained and generated information, to identify items in the database that are relevant to search queries. When a user enters a query, the system searches the index for matching or similar items in the database. Additionally, the system orders the similar items (e.g., to provide a sorted search result to the user) based on the relevancy of the similar items to the query. The system may determine relevancy based on a variety of factors, such as the historical user engagements with an item. For example, an item (or a uniform resource locator associated with the item) that has had many clicks when provided in response to previous search queries may be deemed by the system to be highly relevant to a current search query and/or the system may determine that the item should be moved closer to the top of search results. The system may therefore sort the item higher on a list of search results (e.g., list the item first, highlight the item prominently, etc.) than an item that has not had many interactions or interest from users in response to historical search queries.

In conventional information retrieval systems, it can be challenging to determine how to rank an item that has been newly added to a database for search. For example, newly added items may have not been in the database long enough to have a sufficient amount of corresponding engagement data, which can make it difficult to determine how to rank the newly added items in search results. Further, in some situations item turnover may be common and frequent, in which case items may be available only for a short period of time. For example, a computer networking tool (e.g., a router) may be available for only two months, after which it becomes unavailable. As a further example, a website may frequently be updated with new items for a limited duration. In some instances, by the time a sufficient amount of engagement data has been collected for a newly added item, the item is no longer eligible for including in a search response (e.g., the item is no longer on the website). These and other challenges to conventional information retrieval systems are known as classes of the cold start problem.

The cold start search system described below overcomes these and other challenges posed by the cold start problem to conventional information retrieval systems, thereby providing improved search results of items newly added to a database, by using machine learning to map historical items in the database to the newly added items. As described herein, the cold start search system uses machine learning generated embeddings (e.g., vector representations of items) to determine the extent of similarity between two items. Using the similarity data, the system assigns engagement data associated with an item to other items determined to be similar to that item. For example, the system can assign historical engagement data associated with a first item to a second item newly added to a database and lacking engagement data, thereby enriching the data associated with the newly added item. By doing so, the system enables improved search results because newly added items (that typically lack their own engagement data) can benefit from the engagement data associated with similar historical items. In this way, a newly added item can still be determined to be highly relevant to a search query and/or may be moved to appear closer to the top of search results (e.g., despite initially lacking engagement data), due to the use of engagement data from similar items. Further, the association of engagement data with newly added items, based on similarity data to historical items, improves the efficiency of the cold start search system because the system may need to perform fewer database queries. For example, the improved search functionality may return more relevant search results that enable a user to more quickly identify the item the user is looking for, thereby eliminating the need for additional search queries by the user (and correspondingly enable reduced search processing and database queries by the system). Further, with the cold start problem, newly added items may have no interaction data, which may lead to them being unfairly penalized in a popularity sort resulting in them being shifted to the bottom of the list. This may create a feedback loop where the newly added items are not seen and therefore are not interacted with. The cold start search system described below helps prevent newly added items from stagnating at the bottom of popularity-ranked search results.

In some aspects, the cold start search system receives a search query. The system retrieves, based on the search query, search results from a database of items. For example, the query may be in the form of Structured Query Language (SQL) and may be used to filter rows and columns of a table in a database to obtain search results. As an additional example, the system may search an index and retrieve items that match or are similar to search terms that a user has entered. The search results can include a combination of historical items (e.g., items that have been in the database for at least a threshold duration) and newly added items (e.g., items that have been in database for a length of times less than a threshold duration). Because they have been in the database longer, historical items may have associated therewith engagement data (e.g., data characterizing user interactions in response to the item, such as user click-through data). In contrast, the newly added items may have less or no engagement data. The cold start search system generates, based on a first embedding associated with a historical item from the search results, and a second embedding associated with a newly added item from the search results, a similarity score associated with the historical item and the newly added item. As described herein, the similarity score characterizes the degree of similarity between two items based on their corresponding embeddings. The first embedding and the second embedding may be generated via a machine learning model that has been trained to generate embeddings for items based on corresponding textual descriptions or images. The cold start search system can additionally evaluate whether the similarity score associated with the historical item and newly added item satisfies a similarity threshold. Based on determining that the historical item and the newly added item satisfy a similarity threshold, the system may use an engagement score (e.g., that indicates a number of interactions users have made with the historical item) of the historical item with the new item. For example, the system may assign an engagement score of the historical item to the newly added item. The system may adjust, based on the engagement score assigned to the newly added item, a position of the newly added item within the plurality of search results. Finally, the system may provide the search results to a user.

Various other aspects, features, and advantages of the system will be apparent through the detailed description of the system and the drawings attached hereto. It is also to be understood that both the foregoing general description and the following detailed description are examples and are not restrictive of the scope of the present technology. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

In the following description, for the purposes of explanation, numerous specific details are set forth in order to provide a thorough understanding of the embodiments of the present technology. It will be appreciated, however, by those having skill in the art that the embodiments of the system may be practiced without these specific details or with an equivalent arrangement. In other cases, well-known structures and devices are shown in block diagram form in order to avoid unnecessarily obscuring the embodiments of the system.

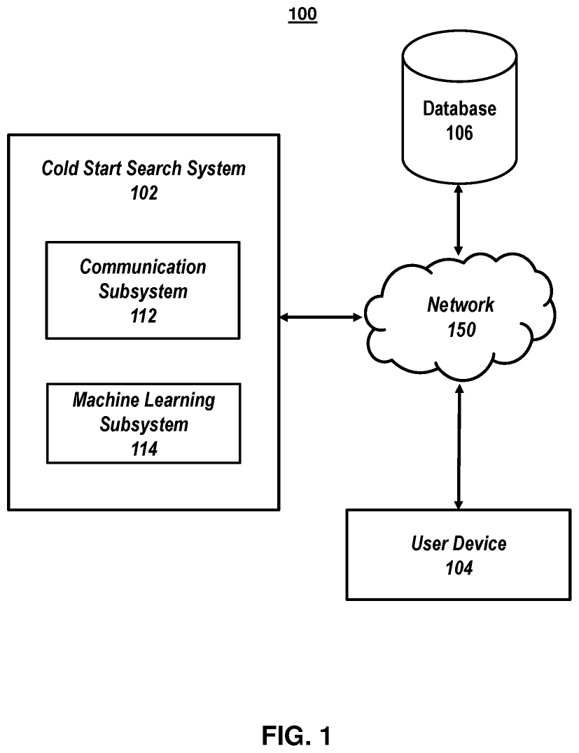

FIG. 1 is an illustrative diagram of a system 100 for using machine learning with information retrieval. The system 100 includes a cold start search system 102, a database 106, and a user device 104 that may communicate with each other via a network 150. Although FIG. 1 shows the database 106 as outside the cold start search system 102, in some embodiments the database 106 may be a part of the cold start search system 102. The cold start search system 102 may include a communication subsystem 112, a machine learning subsystem 114, or other components. The cold start search system 102 may receive a search query. For example, the cold start search system 102 may receive (e.g., via the communication subsystem 112) a search query that includes a plurality of search terms. The search query may be received via the user device 104 and from a user that is searching for a product via e-commerce software (e.g., a mobile application, a web application, etc.). For example, the user may input a query for “red shoes” into the user device 104 and the user device 104 may send the query to the cold start search system 102.

The cold start search system 102 may retrieve (e.g., from the database 106) search results that include multiple items. The items may be data structures that include an indication of websites (e.g., uniform resource locators), other data structures, products (e.g., household items, clothes, electronics, or a variety of other products), or a variety of other items. One or more items in the search results may have been newly added to the database 106 and one or more items may have been in the database 106 for more than a threshold period of time. For example, the cold start search system 102 may retrieve, from the database 106, a plurality of search results that include a first item (e.g., a historical item) and a second item (e.g., a newly added item). A newly added item may be any item that has been interacted with less than a threshold number of times (e.g., three times, ten times, 100 times, 5,000 times, etc.). For example, a newly added item may not have been interacted with by any users. Additionally or alternatively, a newly added item may be any item that has been added to the database 106 within a threshold amount of time (e.g., within the last two weeks, within the last year, within the last hour, etc.). The historical item may have been added to the database 106 more than a threshold amount of time ago. For example, the historical item may have been stored in the database 106 for longer than two weeks, three months, one year, or a variety of other time periods.

As used herein, an interaction with an item may include a user viewing the item, viewing metadata associated with the item, or viewing other content (e.g., images, video, etc.) associated with the item. An interaction may include clicking, tapping, or otherwise interacting with a uniform resource locator associated with the item. An interaction may include purchasing the item, sharing the item (e.g., by sending a link to the item, sharing the item on social media, etc.) or a variety of other actions. An engagement score for an item may include any representation of interactions associated with the item. For example, the engagement score may be a count of the number of interactions that users have had with the item. As an additional example, the engagement score may be a weighted average of the different types of interactions users have had with an item. For example, the weighted average may include a weighted average of the number of purchases of the item and the number of views of the item. In some embodiments, an engagement score may correspond to a query/item pair. That is, an item may have a different engagement score depending on the query for which the item was returned as a result. For example, a red scarf may appear in results for two different queries—“red clothing” being the first query, and “scarf” being the second query. The red scarf may have a first engagement score associated with the first query for “red clothing” and may have a second engagement score associated with the second query for “scarf.” An engagement score associated with a first item may be assigned or otherwise used in connection with a second item, for example, if the cold start search system 102 determines that the two items are similar (e.g., as explained in more detail below).

The cold start search system 102 may determine whether any newly added items are contained within the search results. For any newly added items, the cold start search system 102 may determine whether any other items (e.g., historical items, other items that are not newly added, etc.) are similar. For example, the cold start search system 102 may determine that a first item (e.g., a historical item) and a second item (e.g., a newly added item) satisfy a similarity threshold. In some embodiments, the cold start search system 102 evaluates the similarity between a newly added item contained with the search result and other items in the database 106 that have not been included within the search results. The cold start search system 102 may compare a newly added item with other items in the database 106 to determine if any of the items in the database 106 are similar to the newly added item.

The cold start search system 102 may use a similarity threshold (e.g., as explained in more detail below) to determine whether a newly added item (e.g., contained in a search result) and a historical item or other item with more interactions (e.g., contained in the search result or in the database 106) are similar. The cold start search system 102 may determine that the newly added item and the historical item satisfy a similarity threshold, for example, based on a first embedding associated with the historical item and a second embedding associated with the newly added item. In some embodiments, an embedding space that includes embeddings associated with items (e.g., historical or newly added items) may be designed such that distance or position in the embedding space is representative of the engagement score (e.g., the embedding space may be designed such that popular items cluster into a first region and unpopular items cluster into a second region).

The first embedding and the second embedding may be generated (e.g., using the machine learning subsystem 114) via a machine learning model that has been trained to generate embeddings for items. The machine learning model may have been trained using a dataset that includes textual descriptions (e.g., product description), images, video, user submitted reviews, engagement or interaction data, price, color, item type (e.g., clothing, appliance, jewelry, etc.), a query associated with an engagement score for a corresponding item, or a variety of other information associated with the items. Additionally or alternatively, an embedding may be generated based on one or more videos associated with an item or a size chart associated with an item. An embedding may be generated based on any known information associated with an item.

In some embodiments, the cold start search system 102 may generate embeddings for items in the database 106, and may use the embeddings to determine distance scores (e.g., as described in more detail below) between items, before a search query is received. For example, the cold start search system 102 may receive an indication that a new item has been added to the database 106. Based on the new item being added to the database 106, the cold start search system 102 may generate an embedding for the newly added item. The cold start search system 102 may have previously generated and stored embeddings for other items (e.g., historical items) in the database 106. The cold start search system 102 may use the embeddings to generate distance scores. For example, the system 102 may generate a plurality of distance scores, with each distance score of the plurality of distance scores corresponding to a pair of items comprising the newly added item and one of the historical items in the database 106. The system 102 may assign an engagement score from a historical item to the newly added item. In one example, the system 102 may compare the newly added item with each other item in the database and may assign the engagement score of the most similar historical item in the database. The assigned engagement score can be used when a query is submitted (e.g., at run time), for example, to simplify the query execution process. The embedding of the newly added item may be updated based on the assigned engagement score. By generating embeddings and distance scores before a search query is received, the system 102 may be able to operate more efficiently and respond more quickly when a search query is received.

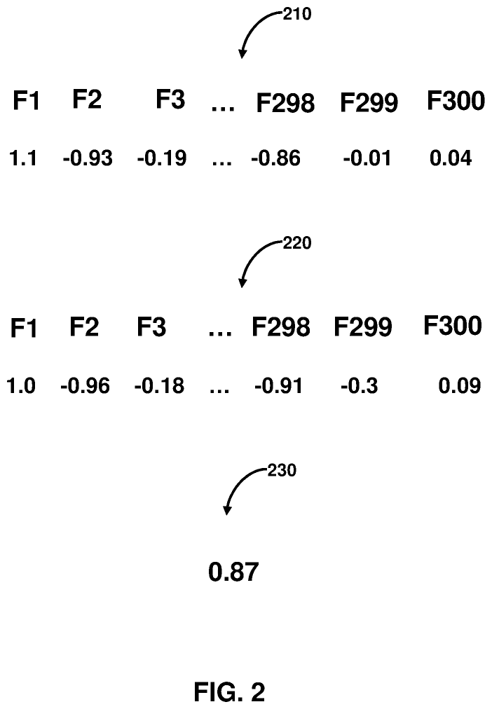

The cold start search system 102 may determine a distance score for two embeddings (e.g., a distance score for the newly added item and the historical item). The distance score may include cosine distance, Manhattan distance, Euclidean distance, or a variety of other distance metrics. For example, FIG. 2 illustrates example item embeddings. In the example illustrated in FIG. 2, the item embeddings 210 and 220, each associated with an item, each contain three hundred features (e.g., values) F1-F300 (not all features are depicted in the figure). The item embedding 210 corresponds to a first item (e.g., a historical item), and the item embedding 220 corresponds to a second item (e.g., a newly added item). For example, the first item may be a green purse made by a first manufacturer and the second item may be a green purse made by a second manufacturer. The item embedding 210 may include features generated based on corresponding product description, images, or user reviews of the green purse made by the first manufacturer. For example, features F1-F100 may correspond to the text description of the first item, features F101-F200 may correspond to images of the first item, and features F201-300 may correspond to user reviews of the first item. Likewise, the item embedding 220 may include features generated based on product description, images, or user reviews of the second item. As described herein, the cold start search system 102 may calculate a distance score 230, characterizing the difference between the first item and the second item, based on the corresponding embeddings 210 and 220. For example, the cold start search system 102 may calculate the distance score 230 based on the cosine distance between the embedding 210 and the embedding 220.

Referring back to FIG. 1, the cold start search system 102 may compare a distance score with a similarity threshold to determine the extent to which two items are similar. If the distance score for two items satisfies a similarity threshold, the cold start search system 102 may classify the two items as sufficiently similar. For example, if a distance score (e.g., a distance score that reflects the dissimilarity between the embeddings of two items, therefore characterizing the items' similarity) is less than a similarity threshold (e.g., threshold distance), the cold start search system 102 may determine that the two corresponding items are similar. In some cases, if a distance score (e.g., cosine similarity) is greater than a similarity threshold, the cold start search system 102 may determine that the two corresponding items are similar. If a distance score fails to satisfy a similarity threshold, the cold start search system 102 may determine that the two corresponding items are not similar. As discussed in more detail below, if the cold start search system 102 classifies two items as similar, the system may assign an engagement score associated with one of the items to the other item, for example, if the other item has insufficient data to create its own engagement score. By doing so, the cold start search system 102 may enable improved search results because the position of newly added items may be adjusted, based on engagement data associated with similar items, within a list of search results. Further, the cold start search system 102 may be able to respond to user requests while performing fewer database queries because the improved search functionality may enable a user to obtain what the user is looking for with fewer search attempts.

The cold start search system 102 may assign an engagement score associated with a historical item to a newly added item. The engagement score may indicate a number of interactions users have had with the historical item. The engagement score may be determined by the cold start search system 102. For example, the cold start search system 102 may determine, based on a number of users that interacted with a user interface element associated with the historical item and based on a median amount of time users spent viewing the historical item, the engagement score for the historical item.

A historical item may be associated with more than one engagement score. A historical item may be associated with multiple engagement scores, for example, if the historical item was returned as a result of multiple queries. The historical item may have an engagement score for each query in which the historical item was a result. Each engagement score may indicate a degree to which the historical item was interacted with after appearing in search results for the corresponding query. For example, a historical item that was returned in a first query and interacted with 100 times may have a higher engagement score for the first query as compared to a second query for which the historical item was interacted with only 10 times. An engagement score associated with a query may be modified, for example, if the query or a similar query is repeated. For example, if a query for red clothing is made a first time and a historical item (e.g., a red scarf) is interacted with ten times, and then in a subsequent query for red clothing, the historical item is interacted with one hundred times, the engagement score may be based on an aggregate of interactions (e.g., average, median, etc.) across the two queries.

The cold start search system 102 may determine which engagement score to assign from a historical item to a newly added item, for example, if there are multiple engagement scores or multiple queries associated with the historical item. The cold start search system 102 may determine which query associated with the historical item most closely matches the query associated with the newly added item. The engagement score associated with the most closely matching query may be assigned to the newly added item. The cold start search system 102 may determine how closely a query matches another query, for example, by generating an embedding for each query and using a distance metric to determine how similar the queries are.

The engagement score may be assigned to a newly added item based on determining that a historical item and the newly added item satisfy a similarity threshold. By doing so, the cold start search system 102 may be able to make inferences about what the engagement score of the newly added item should be, even when the newly added item may have little or no associated engagement data. This may allow the cold start search system 102 to properly order search results that include items that are newly added to the database 106 and may enable newly added items to be discovered more easily by users or other computing systems.

In some embodiments, the cold start search system 102 may determine that multiple items (e.g., historical items) in the search results are similar to a newly added item. The cold start search system 102 may combine engagement scores from each of the similar items, in a variety of ways, and assign the combined engagement score to the newly added item. For example, the cold start search system 102 may determine, based on corresponding embeddings, that both a first historical item and a second historical item found in the search results satisfy a similarity threshold when compared with the newly added item. The cold start search system 102 may generate an average engagement score by averaging the engagement scores of the first historical item and second historical item. The cold start search system 102 may assign the average engagement score to the newly added item.

In some embodiments, the cold start search system 102 may use one or more distance scores indicating distances between a newly added item and one or more other items (e.g., one or more historical items) to determine a weighted engagement score for the newly added item. For example, there may be multiple distance scores with each distance score corresponding to an item pair (e.g., there may be multiple item pairs, each of which is associated with a single distance score). Each item pair may include the newly added item as one of its items. The distance scores can be used to determine a proportion for each corresponding item pair. The proportions may then be used to generate a weighted average engagement score (e.g., by multiplying each proportion with a corresponding engagement score) that may be assigned to the newly added item. For example, the cold start search system 102 may determine a first distance score indicating a distance between the newly added item and a first historical item, and a second distance score indicating a distance between the newly added item and a second historical item. The proportion may be the distance score, for example, if each distance score is a value between 0 and 1. In this example, the first distance score may be multiplied with the engagement score of the first historical item and the second distance score may be multiplied with the engagement score of the second historical item. The resulting two values may then be averaged to create a weighted average engagement score that may be assigned to the newly added item. In one example, the cold start search system 102 may determine, based on the distance score, a proportion; may generate a proportional engagement score by multiplying the engagement score (e.g., that is associated with the first historical item) by the proportion; and may assign the proportional engagement score to the newly added item.

In some embodiments, the cold start search system 102 may select a single engagement score from multiple engagement scores corresponding to items that are similar to a newly added item. For example, the cold start search system 102 may determine, based on corresponding embeddings, that both a first historical item and a second historical item found in the search results satisfy a similarity threshold when compared to the newly added item. If multiple items are similar to the newly added item, the cold start search system 102 may determine which engagement score should be applied to the newly added item. For example, based on the second historical item satisfying the similarity threshold, the cold start search system 102 may compare a second engagement score of the second historical item with a first engagement score associated with the first historical item. Based on the second engagement score being greater than the first engagement score, the cold start search system 102 may assign the second engagement score to the second item. As an additional example, the cold start search system 102 may determine the item that is most similar to the newly added item and may assign the engagement score of the most similar item to the newly added item.

The cold start search system 102 may adjust the position of the newly added item within the search results. The cold start search system 102 may adjust the position of the newly added item within the plurality of search results based on the engagement score assigned by the system to the newly added item. For example, the cold start search system 102 may adjust the position of the newly added item so that it appears earlier (e.g., one or more positions closer to the beginning) in the search results, based on the relative value of the engagement score assigned to the newly added item compared to the engagement scores of other (e.g., historical) items in the search result. Alternatively, the cold start search system 102 may adjust the position of the newly added item so that it appears later (e.g., one or more positions closer to the end of the search results). By doing so, the cold start search system 102 may be able to return search results that are more relevant to a search query. This may increase the efficiency of the cold start search system 102 because, due to the increased relevancy (e.g., increased precision, increased recall, etc.) of results, fewer search queries will be needed to return suitable results to a user.

In some embodiments, the cold start search system 102 may determine to adjust the position of a newly added item within the search results if the engagement score assigned by the system to the newly added item satisfies a threshold. For example, if the engagement score is greater than a first threshold engagement score, the cold start search system 102 may adjust the position one or more places closer to the beginning of the search results. If the engagement score is less than a second threshold engagement score, the cold start search system 102 may adjust the position one or more places closer to the end of the search results. If the engagement score is less than the first threshold engagement score and greater than the second engagement score, the cold start search system 102 may determine that the position of the newly added item should not be adjusted within the search results.

The cold start search system 102 may send the search results to a user device or other computing system. The user device may display the search results in a graphical user interface. In some embodiments, the cold start search system 102 may obtain engagement information based on the displayed search results and use the engagement information to modify the engagement score for the newly added item. For example, based on receiving user engagement information associated with the newly added item, the cold start search system 102 may generate a new engagement score for the newly added item, and assign the new engagement score to the newly added item.

In some embodiments, the cold start search system 102 may use the user engagement information as input to a machine learning model to generate a new embedding for the newly added item. By doing so, the cold start search system may generate an improved embedding that can be used to compare the newly added item with other items in the database 106 to determine whether another item is similar to the newly added item. For example, the cold start search system 102 may receive user engagement information associated with the newly added item. The cold start search system 102 may generate, based on the user engagement information and via a machine learning model, a new embedding for the newly added item.

In some embodiments, the cold start search system 102 may use category data associated with historical items and/or newly added items to determine whether an engagement score from a historical item is to be assigned to a newly added item. In some embodiments, the cold start search system 102 only assigns an engagement score of a historical item to a newly added item if the historical item and newly added item are associated with the same categories. For example, a historical item and a newly item may both be associated with the same category of item (e.g., “shoes”), in which case the cold start system 102 can assign the historical item's engagement score to the newly added item. As a further example, the historical item and newly added item may be associated with different categories of items (e.g., the historical item associated with the category “shoes,” and the newly added item associated with the category “shirts”), in which case the cold start system 102 may not assign the historical item's engagement score to the newly added item, even if the two items satisfy other conditions of the system (e.g., similarity threshold). In some embodiments, the cold start search system 102 can assign an engagement score of a historical item to a newly added item even if the historical item and newly added item are associated with different categories. For example, the cold start search system may assign the engagement score of a historical item, associated with the category “shoes,” to a newly added item associated with the category “handbags,” when the items are sufficiently similar (e.g., they are both red and/or made of leather). In one example, a user may search for “red leather accessories” and the use of cross-category engagement data may enable the cold start search system 102 to surface “red shoes” and “red handbags,” based on the engagement data of one being assigned to the other. In some embodiments, the category data used by the cold start search system 102 can encompass different hierarchies of category data, such as parent categories and subcategories. In some embodiments, the engagement data of an item may be assigned to another item if they belong to the same parent category despite belong to different subcategories. In some embodiments, items in the database 106 may be associated with a category (e.g., shoes, shirts, accessories, mobile phones, etc.).

Although the cold start search system 102 is generally described herein as facilitating the assignment of engagement data associated with a historical item to an item that is newly added to the database 106 and/or an item with insufficient engagement data, in some embodiments the system can assign an engagement score associated with a historical item to an item with stale or out of date engagement data (a “stale item”). A stale item may be an item that has been in the database 106 (e.g., longer than a threshold amount of time) and has some engagement data associated with it, but it has been longer than a threshold amount of time since a user engaged or interacted with the item. For example, it has been longer than a threshold amount of time since any users visited the item's landing page and/or viewed the item in response to the item being returned as a search query result. The cold start system 102 may assign an engagement score of the historical item to the stale item, for example, based on 1) determining that the historical item is associated with user interactions within a threshold time period; 2) determining the stale item has not been interacted with (e.g., within a threshold time period); and/or 3) determining that the historical item is similar to the stale item (e.g., as described herein). As a further example, the cold start search system 102 may assign engagement data of a historical item to a stale item if the historical item and stale item are sufficiently (e.g., as described herein), and the historical item's engagement data is more recent than the stale item's engagement data (e.g., the historical item has been engaged with by users more recently).

In some embodiments, the cold start search system 102 may determine which historical item's engagement score should be used to assign to a newly added item based on personal preferences and/or demographics of a user. Demographics may include age, gender, location, income level, occupation, or a variety of other characteristics related to a user. In one example, if a user performs a query and the cold start search system 102 determines (e.g., based on demographic or other data associated with the user) one or more historical items may not be of interest to the user (e.g., or may not be of interest to a demographic to which the user belongs), then the cold start search system 102 may filter out the one or more historical items or may avoid using any of the one or more items' engagement scores when assigning an engagement score to a newly added item. For example, if the cold start search system 102 identifies that a particular historical item will not be of interest to a user (or one or more demographics to which the user belongs), the system may avoid assigning associated engagement data to a newly added item even if the items are sufficiently similar.

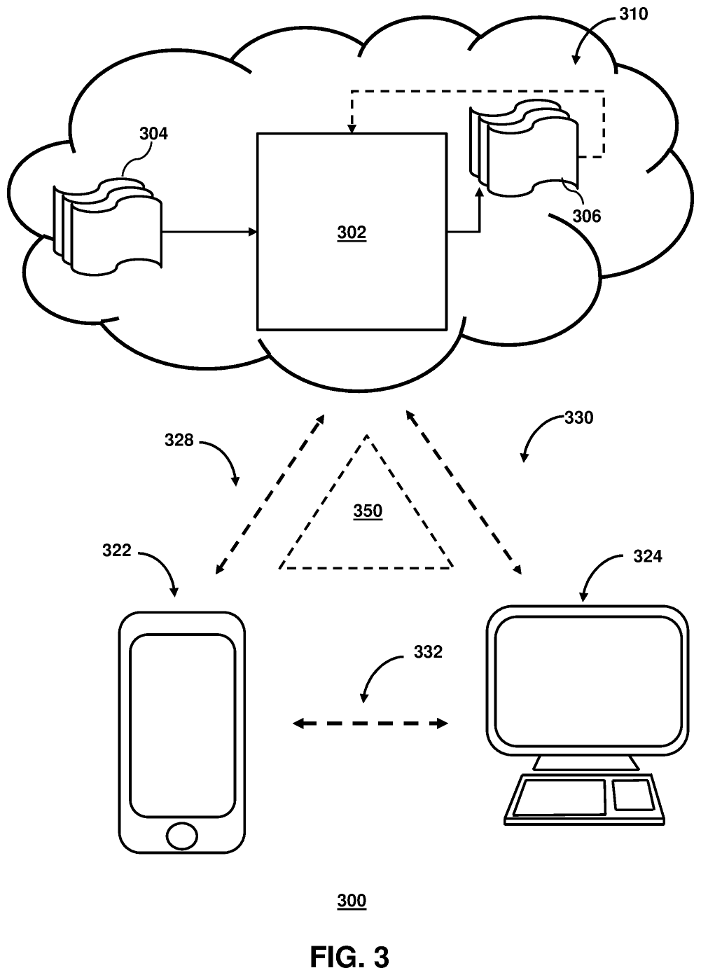

FIG. 3 is a network diagram illustrating an exemplary computing environment 300 in which a cold start search system operates. As described herein, the environment 300 includes components used for the configuration of one or more machine learning models, which may be utilized by the cold start search system and other systems for different purposes. For example, in accordance with one or more embodiments, one or more machine learning models may be utilized to generate embeddings for items (e.g., as described above in connection with FIGS. 1 and 2). The components shown in the environment 300 may be used to perform any of the functionality described above in connection with FIGS. 1 and 2, such as generating embeddings for an item in a database. As illustrated in FIG. 3, the environment 300 may include mobile device 322 and user terminal 324. While shown as a smartphone and personal computer, respectively, in FIG. 3, it will be appreciated that mobile device 322 and user terminal 324 may be any computing device, including, but not limited to, a laptop computer, a tablet computer, a hand-held computer, and other computer equipment (e.g., a server), including “smart,” wireless, wearable, mobile devices, and/or any device or system described in connection with FIGS. 1 and 2. As illustrated in FIG. 3, the environment 300 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It will be appreciated that environment 300 is not limited to three devices. Users may, for instance, utilize one or more devices to interact with one another, one or more servers, or other components of environment 300. It should be noted that, while one or more operations are described herein as being performed by particular components of environment 300, some of which may in combination form a cold start search system, these operations may, in some embodiments, be performed by other components of environment 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with environment 300 and/or one or more components of environment 300. For example, in one embodiment, a first user and a second user may interact with environment 300 using two different components (e.g., using a first mobile device 322 and a second mobile device 322).

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as illustrated in FIG. 3, both mobile device 322 and user terminal 324 include a display upon which to display data (e.g., queries, search results, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device, such as a computer screen, and/or a dedicated input device such as a remote control, mouse, voice input, etc.). Additionally, the devices in environment 300 may run an application (or another suitable program). The application may cause the processors and/or control circuitry to perform operations related to using machine learning with information retrieval, for example, as described above in connection with FIG. 1.

Each of the devices of environment 300 may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

The environment 300 additionally includes communication paths 328, 330, and 332. Communication paths 328, 330, and 332 may include the Internet, a mobile phone network, a mobile voice or data network (e.g., a 5G or Long-Term Evolution (LTE) network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include the cold start search system 102 or the user device 104 described in connection with FIG. 1.

Cloud components 310 may include model 302, which may be a machine learning model, artificial intelligence model, etc. (which may be collectively referred to herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, a cold start search system may receive a first labeled feature input, wherein the first labeled feature input is labeled with a known prediction for the first labeled feature input. The cold start search system may then train the first machine learning model to classify the first labeled feature input with the known prediction (e.g., to generate embeddings for items, to determine the extent to which two items are similar, or a variety of other actions as described above in connection with FIG. 1).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The model (e.g., model 302) may generate a variety of item embeddings based on item data that is input into the model (e.g., as described above in connection with FIGS. 1 and 2).

The environment 300 also includes application programming interface (API) layer 350. API layer 350 may allow the cold start system and other systems or components of the environment 300 to generate summaries across different devices. In some embodiments, API layer 350 may be implemented on user device 322 or user terminal 324. Alternatively, or additionally, API layer 350 may reside on one or more of cloud components 310. API layer 350 (which may be a representational state transfer (REST) or web services API layer) may provide a decoupled interface to data and/or functionality of one or more applications. API layer 350 may provide a common, language-agnostic way of interacting with an application. Web services APIs offer a well-defined contract, called Web Services Description Language (WSDL), that describes the services in terms of its operations and the data types used to exchange information. REST APIs do not typically have this contract; instead, they are documented with client libraries for most common languages, including Ruby, Java, PHP, and JavaScript. Simple Object Access Protocol (SOAP) web services have traditionally been adopted in the enterprise for publishing internal services, as well as for exchanging information with partners in B2B transactions.

API layer 350 may use various architectural arrangements. For example, systems of the environment 300 (including a cold start search system) may be partially based on API layer 350, such that there is strong adoption of SOAP and RESTful web services, using resources like Service Repository and Developer Portal, but with low governance, standardization, and separation of concerns. Alternatively, systems of the environment 300 may be fully based on API layer 350, such that separation of concerns between layers like API layer 350, services, and applications are in place.

In some embodiments, the system architectures of the environment 300 may use a microservice approach. Such systems may use two types of layers: Front-End Layer and Back-End Layer, where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architectures of the environment 300 may use an open API approach. In such cases, API layer 350 may use commercial or open source API platforms and their modules. API layer 350 may use a developer portal. API layer 350 may use strong security constraints applying web application firewall (WAF) and distributed denial-of-service (DDoS) protection, and API layer 350 may use RESTful APIs as standard for external integration.

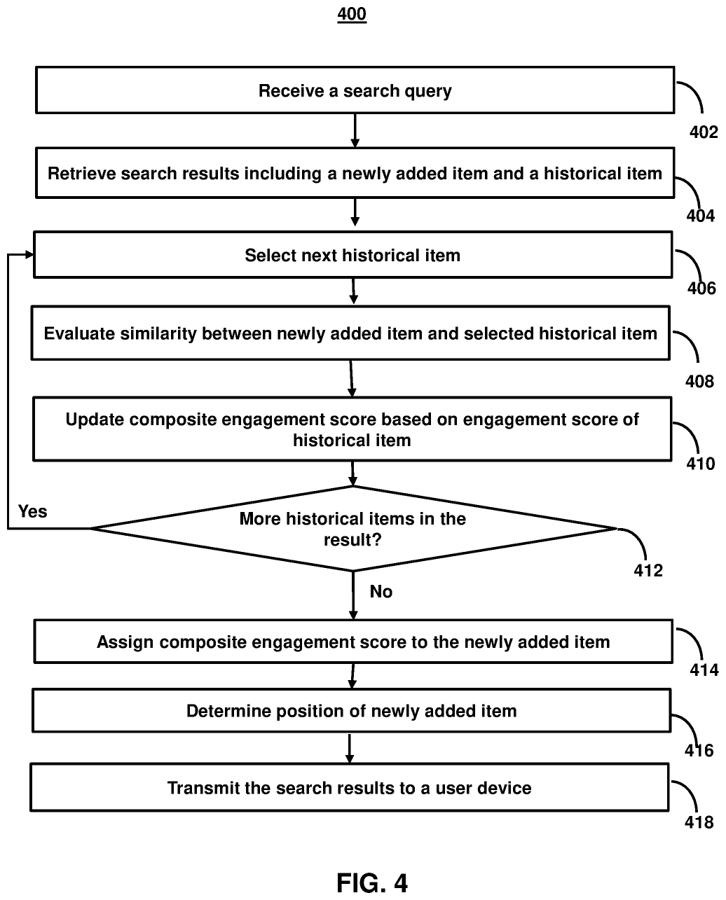

FIG. 4 is a flow diagram illustrating an exemplary process 400, executed by a cold start search system, for identifying items relevant to a search query. Although described as being performed by a cold start search system (e.g., the cold start search system 102 described in connection with FIG. 1), it will be appreciated that one or more of the actions described in connection with the process 400 may be performed by one or more devices shown in FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

The process 400 begins at step 402, where the cold start search system receives a search query. For example, the system may receive, from a user device, a search query comprising a plurality of search terms. The search query may be received via a user device and from a user that is searching for a product via e-commerce software (e.g., a mobile application, a web application, etc.). For example, the user may input a query for “red shoes” into a user device, from which the query is transmitted to the system.

At step 404, the system retrieves search results, based on the search query, that include one or more items that are responsive to the search query. For example, the system may identify items in an item database (such as database 106 discussed in connection with FIG. 1) that may be relevant to the search query. The search results may include at least one historical item and at least one newly added item. As described herein, the newly added item may be characterized by having little or no associated engagement data, which can render it challenging to evaluate how relevant the newly added item is to the search query. For example, the newly added item may have been interacted with less than a threshold number of times (e.g., insufficient engagement data to rely on). As a further example, the newly added item may not have been interacted with at all by any users (e.g., no engagement data). Additionally or alternatively, the newly added item may have been added to the item database within a threshold amount of time (e.g., within the last two weeks, within the last year, within the last hour, etc.). In contrast, the historical item may have been added to the item database more than a threshold amount of time ago. For example, the historical item may have been stored in the item database for longer than two weeks, three months, one year, or a variety of other time periods. Additionally or alternatively, the historical item may be characterized by having a greater amount of engagement data associated therewith.

At step 406, the cold start search system selects a historical item from the search results to compare to the newly added item. As illustrated in FIG. 4 and described further herein, the cold start search system may perform a loop (e.g., through repeated processing of steps 406-412) to compare the newly added item to multiple items in the search result (e.g., all historical items). For each historical item that is similar to the newly added item, the cold start search system may use one or more corresponding engagement scores to determine an engagement score for the newly added item, for example, as discussed in more detail below.

At step 408, the cold start search system may evaluate the similarity between the newly added item and the item selected at step 406. For example, the cold start search system may determine that the selected historical item and the newly added item satisfy a similarity threshold. The cold start search system may determine that the selected historical item and the newly added item satisfy a similarity threshold, for example, based on a first embedding associated with the selected historical item and a second embedding associated with the newly added item. The similarity threshold may be a similarity threshold described above in connection with FIG. 1 or a variety of other similarity thresholds. The first embedding and the second embedding may be generated (e.g., using a machine learning subsystem) via a machine learning model that has been trained to generate embeddings for items. The machine learning model may have been trained using a dataset that includes textual descriptions, images, or a variety of other information (e.g., as described above in connection with FIGS. 1-3) associated with the items.

In some embodiments, the cold start search system may compare a first embedding associated with the selected historical item with a second embedding associated with the newly added item to determine whether the selected item is similar to the newly added item. For example, the search system may determine, based on a comparison of the first embedding and the second embedding, a distance score (e.g., using any distance score described above in connection with FIG. 1). The cold start search system may determine that the selected historical item and newly added item are similar, for example, if the distance score is lower than the similarity threshold.

At step 410, the cold start search system may update a composite engagement score based on the engagement score of the selected historical item. For example, if the selected historical item is similar to the newly added item, the engagement score of the selected historical item may be averaged with engagement scores of other historical items that are similar to the newly added item (e.g., as identified from a loop formed of steps 406-412 as described herein). In some embodiments, the composite engagement score may be a weighted average of the engagement scores of the selected items that are similar to the newly added item.

In some embodiments, the cold start search system may select a single engagement score from multiple engagement scores corresponding to items that are similar to a newly added item. For example, the cold start search system may determine, based on corresponding embeddings, that both a first selected historical item and a second selected historical item found in the search results satisfy a similarity threshold when compared to the newly added item. If multiple items are similar to the newly added item, the cold start search system may determine which engagement score should be applied to the newly added item. For example, the item with the highest engagement score may be used as the composite engagement score. As an additional example, the cold start search system may determine the item that is most similar to the newly added item should be used as the composite engagement score.

At step 412, the cold start search system may determine whether there are additional historical items in the search results. If there are additional historical items in the search results, the system returns to step 406 (e.g., to repeat the loop of steps 406-412). If there are no additional historical items in the search results, processing proceeds to step 414.

At step 414, the cold start search system may assign the composite engagement score (based on the one or more historical items of sufficient similarity to the newly added item) to the newly added item. The engagement score may indicate, alone or in aggregate, a number of interactions users have had with the similar historical items. The engagement score may be any engagement score described above in connection with FIG. 1. The engagement score may be assigned to the newly added item based on determining that the historical items associated with the composite engagement score and the newly added item satisfy the similarity threshold. By doing so, the search system may be able to make inferences about what the engagement score of the newly added item should be, even though the newly added item may have little or no associated engagement data. This may allow the cold start search system to properly order search results that include items that are newly added to the database 106 and may enable newly added items to be discovered more easily by users or other computing systems.

In some embodiments, the cold start search system may use one or more distance scores indicating distances between the newly added item and one or more other items to determine a weighted engagement score for the newly added item. For example, there may be multiple distance scores with each distance score corresponding to an item pair. Each item pair may include the newly added item as one of its items. The distance scores can be used to determine a proportion for each corresponding item pair. The proportions may then be used to generate a weighted average engagement score (e.g., by multiplying each proportion with a corresponding engagement score) that may be assigned to the newly added item. For example, the cold start search system may determine a first distance score indicating a distance between the newly added item and the selected historical item, and a second distance score indicating a distance between the newly added item and a second selected historical item. For example, the proportion may be the distance score, for example, if each distance score is a value between 0 and 1. In this example, the first distance score may be multiplied with the engagement score of the selected historical item and the second distance score may be multiplied with the engagement score of the second selected historical item. The resulting two values may then be averaged to create a weighted average engagement score that may be assigned to the newly added item. In one example, the cold start search system may determine, based on the distance score, a proportion; may generate a proportional engagement score by multiplying the engagement score (e.g., that is associated with the selected historical item) by the proportion; and may assign the proportional engagement score to the newly added item.

At step 416, the system determines the position of the newly added item within the search results. The system may determine the position of the newly added item within the plurality of search results based on the engagement score that was assigned to the newly added item at step 414. For example, the system may adjust the position of the newly added item so that it appears earlier (e.g., one or more positions closer to the beginning) in the search results. Alternatively, the system may adjust the position of the newly added item so that it appears later (e.g., one or more positions closer to the end of the search results). By doing so, the system may be able to return search results that are more relevant to a search query. This may increase the efficiency of the system due to the increased relevancy (e.g., increased precision, increased recall, etc.) of results, which may enable fewer search queries that will be needed to be performed to generate satisfactory search results for a user.

In some embodiments, the system may determine to adjust the position of the newly added item within the search results if the engagement score assigned to the newly added item satisfies a threshold. For example, if the engagement score (e.g., assigned in step 414) is greater than a first threshold engagement score, the system may adjust the position one or more places closer to the beginning of the search results. If the engagement score is less than a second threshold engagement score, the system may adjust the position one or more places closer to the end of the search results. If the engagement score is less than the first threshold engagement score and greater than the second engagement score, the system may determine that the position of the newly added item should not be adjusted within the search results.

At step 418, the system transmits the search results to a user device or other computing system. The user device may display the search results in a graphical user interface.

In some embodiments, the system may receive engagement information based on the displayed search results, and use the engagement information to modify the engagement score for the newly added item. For example, based on receiving user engagement information associated with the newly added item, the system may generate a new engagement score for the newly added item, and assign the new engagement score to the newly added item.

In some embodiments, the system may use the user engagement information as input to a machine learning model to generate a new embedding for the newly added item. By doing so, the search system may generate an improved embedding that can be used to compare the newly added item with other items to determine whether another item is similar to the newly added item. For example, the system may receive user engagement information associated with the newly added item. The system may generate, based on the user engagement information and via a machine learning model, a new embedding for the newly added item.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Although one or more of the above-described embodiments describe assigning to a newly added item an engagement score based on one or more historical items, the above-described embodiments may use or be performed for any combination of items from a collection of items (e.g., assigning to a second item an engagement score associated with a first item, or assigning to the second item an engagement score based on engagement scores associated with the first item, a third item, etc.).

The present techniques will be better understood with reference to the following enumerated embodiments:
1. A method comprising: receiving, from a user device, a search query comprising a plurality of search terms; retrieving, based on the search query and from a database, a plurality of search results comprising a first item and a second item; determining, based on a first embedding associated with the first item and a second embedding associated with the second item, that the first item and the second item satisfy a similarity threshold; based on determining that the first item and the second item satisfy a similarity threshold, assigning a first engagement score of the first item to the second item, adjusting, based on the first engagement score, a position of the second item within the plurality of search results; and sending a portion of the plurality of search results to the user device.
2. The method of the preceding embodiment, wherein the first engagement score indicates a number of interactions users have made with the first item.
3. The method of any of the preceding embodiments, wherein assigning the first engagement score of the first item to the second item comprises: determining, based on a third embedding associated with a third item of the plurality of search results, that the third item satisfies the similarity threshold when compared with the second item; based on the third item satisfying the similarity threshold, generating an average engagement score by averaging the first engagement score with an engagement score of the third item; and assigning the average engagement score to the second item.
4. The method of any of the preceding embodiments, further comprising: determining, based on a number of users that interacted with a user interface element associated with the first item and based on a median amount of time users spent viewing the first item, the first engagement score.
5. The method of any of the preceding embodiments, wherein determining that the first item and the second item satisfy a similarity threshold comprises: determining, based on a comparison of the first embedding and the second embedding, a distance score; and determining that the distance score is lower than the similarity threshold.
6. The method of any of the preceding embodiments, wherein assigning the first engagement score of the first item to the second item comprises: determining, based on the distance score, a proportion; generating a proportional engagement score by multiplying the first engagement score by the proportion; and assigning the proportional engagement score to the second item.
7. The method of any of the preceding embodiments, wherein the first embedding and second embedding are generated via a machine learning model that has been trained to generate embeddings for items based on corresponding textual descriptions and images.
8. The method of any of the preceding embodiments, further comprising: based on receiving user engagement information associated with the second item, generating a new engagement score for the second item; and assigning the new engagement score to the second item.
9. The method of any of the preceding embodiments, further comprising: receiving user engagement information associated with the second item; and generating, based on the user engagement information and via a machine learning model, a new embedding for the second item.
10. The method of any of the preceding embodiments, wherein assigning the first engagement score of the first item to the second item comprises: determining, based on a third embedding associated with a third item of the plurality of search results, that the third item satisfies the similarity threshold when compared with the second item; based on the third item satisfying the similarity threshold, comparing a second engagement score of the third item with the first engagement score; and based on the second engagement score being greater than the first engagement score, assigning the second engagement score to the second item.
11. The method of any of the preceding embodiments, wherein the first embedding and second embedding are generated using bidirectional encoder representations from transformers or global vectors for word representation.
12. A tangible, non-transitory, machine-readable medium storing instructions that, when executed by a data processing apparatus, cause the data processing apparatus to perform operations comprising those of any of embodiments 1-11.
13. A system comprising one or more processors; and memory storing instructions that, when executed by the processors, cause the processors to effectuate operations comprising those of any of embodiments 1-11.
14. A system comprising means for performing any of embodiments 1-11.

What is claimed is:

1. An information retrieval system for improving search results for items newly added to a database by using machine learning to map historical items in the database to the newly added items, the system comprising:
one or more processors programmed with computer program instructions that, when executed by the one or more processors, cause operations comprising:
receiving, from a user device, a search query comprising a plurality of search terms;
retrieving, based on the search query and from the database, a plurality of search results comprising a historical item and a newly added item, wherein the newly added item has been interacted with less than a threshold number of times;
determining, based on a first embedding associated with the historical item and a second embedding associated with the newly added item, that the historical item and the newly added item satisfy a similarity threshold, wherein the first embedding and second embedding are generated via a machine learning model that has been trained to generate embeddings for items based on corresponding textual descriptions and images;
based on determining that the historical item and the newly added item satisfy a similarity threshold, assigning a first engagement score of the historical item to the newly added item, wherein the first engagement score indicates a number of interactions users have made with the historical item;
adjusting, based on the first engagement score, a position of the newly added item within the plurality of search results; and
sending the plurality of search results to the user device.

2. A method comprising:
receiving, from a user device, a search query comprising a plurality of search terms;
retrieving, based on the search query and from a database, a plurality of search results comprising a first item and a second item;
determining, based on a first embedding associated with the first item and a second embedding associated with the second item, that the first item and the second item satisfy a similarity threshold;
based on determining that the first item and the second item satisfy a similarity threshold, assigning a first engagement score of the first item to the second item, wherein the first engagement score indicates a number of interactions users have made with the first item;
adjusting, based on the first engagement score, a position of the second item within the plurality of search results; and
sending a portion of the plurality of search results to the user device.

3. The method of claim 2, wherein assigning the first engagement score of the first item to the second item comprises:
determining, based on a third embedding associated with a third item of the plurality of search results, that the third item satisfies the similarity threshold when compared with the second item;
based on the third item satisfying the similarity threshold, generating an average engagement score by averaging the first engagement score with an engagement score of the third item; and
assigning the average engagement score to the second item.

4. The method of claim 2, further comprising:
determining, based on a number of users that interacted with a user interface element associated with the first item and based on a median amount of time users spent viewing the first item, the first engagement score.

5. The method of claim 2, wherein determining that the first item and the second item satisfy a similarity threshold comprises:
determining, based on a comparison of the first embedding and the second embedding, a distance score; and
determining that the distance score is lower than the similarity threshold.

6. The method of claim 5, wherein assigning the first engagement score of the first item to the second item comprises:
determining, based on the distance score, a proportion;
generating a proportional engagement score by multiplying the first engagement score by the proportion; and
assigning the proportional engagement score to the second item.

7. The method of claim 2, wherein the first embedding and second embedding are generated via a machine learning model that has been trained to generate embeddings for items based on corresponding textual descriptions and images.

8. The method of claim 2, further comprising:
based on receiving user engagement information associated with the second item, generating a new engagement score for the second item; and
assigning the new engagement score to the second item.

9. The method of claim 2, further comprising:
receiving user engagement information associated with the second item; and
generating, based on the user engagement information and via a machine learning model, a new embedding for the second item.

10. The method of claim 2, wherein assigning the first engagement score of the first item to the second item comprises:
determining, based on a third embedding associated with a third item of the plurality of search results, that the third item satisfies the similarity threshold when compared with the second item;
based on the third item satisfying the similarity threshold, comparing a second engagement score of the third item with the first engagement score; and
based on the second engagement score being greater than the first engagement score, assigning the second engagement score to the second item.

11. The method of claim 2, wherein the first embedding and second embedding are generated using bidirectional encoder representations from transformers or global vectors for word representation.

12. A non-transitory, computer-readable medium comprising instructions that when executed by one or more processors, causes operations comprising:
receiving, from a user device, a search query comprising a plurality of search terms;
retrieving, based on the search query and from a database, a plurality of search results comprising a first item and a second item;
determining, based on a first embedding associated with the first item and a second embedding associated with the second item, that the first item and the second item satisfy a similarity threshold;
based on determining that the first item and the second item satisfy a similarity threshold, assigning a first engagement score of the first item to the second item, wherein the first engagement score indicates a number of interactions users have made with the first item;
adjusting, based on the first engagement score, a position of the second item within the plurality of search results; and
sending a portion of the plurality of search results to the user device.

13. The medium of claim 12, wherein assigning the first engagement score of the first item to the second item comprises:
determining, based on a third embedding associated with a third item of the plurality of search results, that the third item satisfies the similarity threshold when compared with the second item;
based on the third item satisfying the similarity threshold, generating an average engagement score by averaging the first engagement score with an engagement score of the third item; and
assigning the average engagement score to the second item.

14. The medium of claim 12, wherein the instructions, when executed, cause operations further comprising:
determining, based on a number of users that interacted with a user interface element associated with the first item and based on a median amount of time users spent viewing the first item, the first engagement score.

15. The medium of claim 12, wherein determining that the first item and the second item satisfy a similarity threshold comprises:
determining, based on a comparison of the first embedding and the second embedding, a distance score; and
determining that the distance score is lower than the similarity threshold.

16. The medium of claim 15, wherein assigning the first engagement score of the first item to the second item comprises:
determining, based on the distance score, a proportion;
generating a proportional engagement score by multiplying the first engagement score by the proportion; and
assigning the proportional engagement score to the second item.

17. The medium of claim 12, wherein the first embedding and second embedding are generated via a machine learning model that has been trained to generate embeddings for items based on corresponding textual descriptions and images.

18. The medium of claim 12, wherein the instructions, when executed, cause operations further comprising:
based on receiving user engagement information associated with the second item, generating a new engagement score for the second item; and
assigning the new engagement score to the second item.

19. The medium of claim 12, wherein the instructions, when executed, cause operations further comprising:
receiving user engagement information associated with the second item; and
generating, based on the user engagement information and via a machine learning model, a new embedding for the second item.

20. The medium of claim 12, wherein assigning the first engagement score of the first item to the second item comprises:
determining, based on a third embedding associated with a third item of the plurality of search results, that the third item satisfies the similarity threshold when compared with the second item;
based on the third item satisfying the similarity threshold, comparing a second engagement score of the third item with the first engagement score; and
based on the second engagement score being greater than the first engagement score, assigning the second engagement score to the second item.
